(19) United States
(12) Patent Application Publication
(10) Pub. No.: US 2008/0195599 A1
(43) Pub. Date: Aug. 14, 2008

(54) Hyperlink content abstraction

(75) Inventor: Henry Neils, Chanhassen, MN (US)

Correspondence Address: BROOKS, CAMERON & HUEBSCH , PLLC, 1221 NICOLLET AVENUE , SUITE 500, MINNEAPOLIS, MN, 55403, US

(73) Assignee: ZH Computer, Inc.

(21) Appl. No.: 11/705,841

(22) Filed: Feb. 14, 2007

(51) Int. Cl. G06F 17/30; G06F 17/00; G06F 17/28

(52) U.S. Cl. 707/5; 707/E17.071; 715/205; 715/208

(57) ABSTRACT

Embodiments for hyperlink content abstraction are disclosed. In one embodiment a method of hyperlink content abstraction includes selecting a hyperlink with a user directed pointing device, implementing computing device executable instructions to access an electronic document linked to the hyperlink, analyzing a number of content items within the electronic document to determine the content of the document, and compiling a summary of the content of the electronic document based upon the analysis.

### INTRODUCTION

Hyperlinks are links that allow a user to select the link which directs the user's computing device to show information about the subject of the hyperlink. A hyperlink (e.g., often referred to as a link), is a reference or navigation element in a document. The element can be used, for example, to provide a path to another section of the same document in which the element resides, to another document, or to a specified section of another document.

Hyperlinks are often designed to automatically bring the linked information to the user when the navigation element is selected by the user. A computing device can be instructed to obtain the link resource that is referenced if the computing device includes a data network and suitable access protocol instructions.

Hyperlinks may be used in almost any electronic media. For instance, hyperlinks are used in word processing documents, spreadsheets, databases, and other types of electronic documents.

For example, a table of contents in an electronic document may have a hyperlink that directs the reader to a section of the overall text. By selecting the hyperlink, the user's computing device is directed to the section and the section is provided, for example, on a display of the computing device, among other sensory output component possibilities.

Further, one of the greatest uses of hyperlinks is on the Internet. With respect to Internet usage, a web page can include a number of hyperlinks for access to other information on the Internet.

For example, a news site can include a number of hyperlinks each representing a story that can be accessed if the user wants to read the story. This can be accomplished by selecting the hyperlink. Likewise, as above, by selecting the hyperlink, the user's computing device is directed to a section of a document and the section is provided for reading, or other use, by the user.

When a hyperlink is used, it typically includes some text or image that is a target that a user selects. In the field of Internet navigation and in some computing device applications, the manner of selection is made through use of a mouse or other input device and a pointer on a display of the computing device.

In such systems, the user maneuvers the pointer through manipulation of the mouse or other input device until the pointer is over the target. The user then indicates selection of the target, for example, by pressing a key or button on an input device such as the mouse or a keyboard. Such manipulation can also be accomplished in many other manners, such as by touching a touch screen, using arrow keys on a keyboard, or using a roller ball, among other mechanisms.

In such applications, sometimes the information provided (e.g., text and/or images) does not provide a good indication of what the subject matter to be accessed refers to. For instance, an example hyperlink reads “stunning accusation”.

The information to be accessed by selecting that hyperlink could relate to almost anything. Accordingly, a user may not want to bother to select the link for a number of reasons based upon their lack of information.

For example, the user may not have time to read into the article to learn whether or not they are interested in the subject matter contained therein. The user may be fearful that selecting the link may lead them to information that is inappropriate or potentially harmful to their computing device, among other reasons.

Such reluctance is especially true when the source of the document is unknown or the source of the link is unknown. In some instances, a user can obtain a heightened level of security based upon the context or the location of the hyperlink with other information that the user feels is more trustworthy.

For example, if provided with a number of hyperlinks to reliable news sources, it may be inferred that the subject hyperlink is also a reliable source. However, this may not be true in all cases.

Further, hyperlinks are also used in many search engines that are utilized in the fields of Internet navigation and computing device technology generally. In many search engines, the front page of Internet websites are copied to a server and their text is analyzed and classified into a database. This database is accessible through executable instructions that can be provided as a web portal or other software incarnation.

The access through such a web portal allows users to search the database in order to find websites that may contain information that is relevant to their search request. In order to accomplish such access, a user typically enters a number of keywords into the web portal, for example.

This keyword information is taken by the server and executable instructions use the information to search the database. In many systems, the results that have the most uses of the keywords are placed at the top of the search results and the ones that have the least uses are placed at the bottom.

Such search engines also typically provide a hyperlink to the relevant website, thereby making access to the website simple. The hyperlink, as discussed above, can be provided, for example, by text and/or images, among other forms of expression. Such hyperlink identifiers often suffer from the same descriptiveness and other issues as discussed above.

Some search engines also provide some examples of how the keyword(s) are used in context. Although such information can be helpful in understanding whether the website identified contains the correct information that the user is seeking, in some instances, the information may not be helpful.

For example, the information recited may be non-sensical or may not provide enough information to make a determination about the content of the subject website. However, in some instances, the keyword examples do not provide any helpful information about the website or its contents.

### BRIEF DESCRIPTION OF THE DRAWINGS

FIG. 1 illustrates a computing system suitable for use with embodiments of the present disclosure.

FIG. 2 illustrates a search result having a hyperlink title and a summary.

FIG. 3 illustrates an embodiment of a summarization feature embodiment of the present disclosure.

FIGS. 4A and 4B illustrate the source content of a document provided in the search result of FIG. 2 and content of the summarization in FIG. 3.

### DETAILED DESCRIPTION

Embodiments of the present disclosure can be used to provide a user with additional information about the contents of a document that is accessible by hyperlink. Accordingly, generally, the present disclosure includes a number of method and device embodiments for hyperlink content abstraction.

As used herein, abstraction is the act of withdrawing or removing content from a document and forming a summary therefrom. A summary can take a number of suitable forms, such as a number of sentences, a number of paragraphs, and/or a number of bullet points, among other summary forms. In some embodiments, a user can choose the form of the summary that they would like displayed.

The present disclosure includes a number of method embodiments. In some embodiments, for instance, the method can include selecting a hyperlink with a user directed pointing device. The hyperlink can be present in any type of electronic document and can direct a user to an electronic document that can also be of any type.

For example, in such method embodiments, computing device executable instructions can be implemented to access an electronic document linked to the hyperlink. An electronic document as used herein means any document that is provided in an electronic form and is accessible by a computing device. For example, electronic documents include, but are not limited to word processing documents, spreadsheet documents, web page documents (e.g., a hyper text markup language format, an extensible markup language format, etc.), database documents, portable document format documents, and other types of documents created by application software that can be stored and/or used with a computing device.

The term pointing device as it is used herein can be any device that can be used by user to indicate selection of an item presented by a computing device. For example, a pointing device can be a mouse, a scroll wheel, roller ball, a number of directional keys (e.g., arrow keys on a keyboard or key pad) a touch screen, or other such devices.

Through such access, a number of content items can be analyzed within the electronic document to determine the content of the document. Based upon the analysis of the number of items within the electronic document, a summary of the content of the electronic document can be compiled.

The analysis can be accomplished by various manners. For example, in some embodiments, the analysis can be performed by executing computing device executable instructions to analyze a number of words within the electronic document. This analysis can be done to identify the meaning of a term or to identify or calculate a value that has been assigned or that is to be assigned to one or more of the content items (e.g., words) of the document.

In various embodiments, the analysis of the content of the electronic document can be accomplished by executable instructions stored in memory and logic circuitry (e.g., a processor, application specific integrated circuit (ASIC) or other logic type circuitry). Such, logic and memory can be resident on the user's computing device and/or a remote computing device, such as a server or main frame computing device among other types of computing devices.

In some embodiments, the analysis of the number of content items can be accomplished, by analyzing the content of the document without downloading the document from the computing device upon which it is stored. In such embodiments, such analysis can be beneficial in using less memory during the analysis process and in using less network bandwidth since the document will not have to be transferred from the source computing device to the computing device doing the analysis.

The analysis of the number of content items can also be accomplished, in some embodiments, by obtaining a copy of the electronic document and executing computing device executable instructions to analyze one or more content items within the electronic document. In some embodiments, the copy of the electronic document can be stored on a server that is located remotely from the user, and in various embodiments, the user's computing device may be the location where the copy is stored.

In some embodiments, analyzing a number of content items can include executing computing device executable instructions to interpret a value of a particular content item with respect to the electronic document based upon a value for the particular content item assigned with respect to a neutral context. In such embodiments, it may be possible to have values determined for a number of content items in a neutral context before the analysis is initiated and as such these values can be obtained and applied in the analysis of the content items more quickly than if they were to be determined at the time the content items were being accessed and analyzed.

The analysis of a number of content items can also include executing computing device executable instructions to interpret a value of a particular content item with respect to the electronic document based upon a value for the particular content item assigned with respect to at least one other content item in the electronic document. In such embodiments, the natural language connection of one or more words, for example, can be used to determine how the words should be used in the summary of the electronic document.

Additionally, the context of the document can be interpreted by assigning values to a number of content items and the comparison of these values can be used to determine the content of the summary. Determining the content of the summary can be done to determine the content items to be used in the summary, the order of the content items, and/or whether any of the content items should be modified or substituted in order to make the summary more readable. The last item can be helpful, in some embodiments, since the terms in the document may not read correctly or impart the correct meaning when used in a summary that contains less than the entire original document.

Through use of such embodiments as described herein, a user can view a summary of the document rather than the entire document. This can be beneficial for a number of reasons. For example, this can allow a user to better understand what is in the document before having to begin reading the document.

Additionally, the user does not have to direct their computing device to the document because the summary can be delivered to the display of their computing device without it ever leaving the page in which the hyperlink resides. In this way, the user can identify whether a document is of interest, and if not, they can continue on the page they were navigating before they came across the hyperlink.

Such functionality can reduce the amount of network traffic since the user is not traveling back and forth to and from pages that they were not interested in reading. This would also reduce the amount of processing power that may be used when navigation the network.

Embodiments are also included where the method is provided on a computer readable medium. As used herein, a computer readable medium is intended to include any type of material that a computer is capable of reading information from. Information can include data or instructions that can be executed by logic circuitry on a computing device.

For example, computer readable mediums can include optical or magnetic media, among other types and can include random access memory (RAM), read only memory (ROM), and/or Flash memory. Embodiments as will be described further herein can be included with a computer readable medium and may also be provided using a carrier wave over a communications network such as the Internet, among others.

As the reader will appreciate, various embodiments described herein can be performed by software, application modules, application specific integrated circuit (ASIC) logic, and/or executable instructions operable on the systems and devices shown herein or otherwise. “Software”, as used herein, includes a series of executable instructions that can be stored in memory and executed by hardware logic, such as within a processor (e.g., transistor gates), to perform a particular task. An “application module” means a self-contained hardware or software component that interacts with a larger system.

As the reader will appreciate a software module may come in the form of a file and handle a specific task within a larger software system. A hardware module may be a separate set of logic, e.g., transistor/circuitry gates, that “plug-in” as a card, appliance, or otherwise, to a larger system/device.

Embodiments of the present disclosure, however, are not limited to any particular operating environment or to executable instructions written in a particular language or syntax. Software, application modules and/or logic, suitable for carrying out embodiments of the present disclosure, can be resident in one or more devices or locations or in several devices and/or locations in a network. Additionally, embodiments of the present disclosure can be utilized on a single stand alone computing device having a number of electronic documents stored in memory on the computing device or associated therewith (e.g., external storage devices, etc.) or on a network that includes two or more computing devices.

In some method embodiments, the method can, for example, include receiving a request for a summary of a document from a user based upon a user's selection of a hyperlink. For instance, as discussed above, the request can be to summarize a document that is provided in one of a number of formats. For example, the document format can be a word processing document, a hyper text markup language document, a portable document format document, or an extensible markup language document, among other electronic document formats.

An electronic document linked to the hyperlink can be accessed based upon information received in the request. A number of content items within the document can be analyzed to determine the content of the document. Based upon the analysis of the number of content items, a summary of the content of the document can be compiled.

The present disclosure also includes a number of computing device embodiments. In some embodiments, for example, the computing device can include a processor, memory coupled to the processor, and instructions storable in the memory and executable by the processor.

In such embodiments, the executable instructions can be provided to enable the computing device to receive a request for a summary of a document from a user based upon the user's selection of a hyperlink. Instructions can also be provided to access an electronic document linked to the hyperlink based upon information received in the request.

A number of words within the document can also be analyzed through use of executable instructions on the device to determine the content of the document. Executable instructions can be used to extract a number of words from the content of the document and compile a summary based the number of words extracted and upon the analysis of the number of words.

In some embodiments, the instructions can be executable to modify one or more of the extracted words based upon a proposed position within the summary. This can be accomplished by changing the form of the word, such as from singular to plural form, from an adjective to a noun or verb, or other such changes as may be suitable to improve the readability of the summary. Additionally, in some embodiments, the modification can be to substitute another word that provides a similar meaning, but is more readable in the context of the summary.

In such embodiments, where such modification functionality is provided, the modifications can be provided by executable instructions that can determine when a modification is to be made based upon a number of grammatical and/or context based rules that dictate the modification process. Further, such rules can be stored in memory, for example, in a table or database and executable instructions can be used to access such files and use the contents to perform the modifications.

In some embodiments, the instructions are executable to use one or more of the extracted words exactly as extracted in compiling the summary. In some such embodiments, all of the extracted words can be used exactly as extracted. Such embodiments can be beneficial, for example, because the creation of the summary can be accomplished faster and/or with less computing power than if modifications are to be made, among other benefits.

In various embodiments, instructions can executable to compile the summary from a number of words and the positions of the words of the summary can be based upon a proposed word order structure for the summary. For example, if the proposed word order is a sentence, the sentence can be constructed according to one of a number of standard sentence structures that are commonly known.

In this way, if a word that is extracted is a verb and the sentence does not have a verb, the extracted verb may be positioned in the correct position for a verb in the standard sentence format being used. This can also be applied to groups of words that are extracted, in some embodiments.

For example, if a noun and verb are used in the document together, that noun and verb can be positioned to be used together in the summary. These terms can also be modified in some embodiments, to make them more readable in the summary, but such that they can still be used together.

As discussed above, a value can be assigned to one or more words and these values can be used to determine the position of the words in the summary. For example, words can be assigned values according to a number of different criteria.

For instance, values can be established based upon whether a word is used as a noun or a verb. In some embodiments, a value can be higher or lower based upon whether one or more other words are present in the document (e.g., gas can have one value if used with the word balloon and another value if used with automobile).

In some such embodiments, the values for each term that is associated can be increased or decreased (e.g., gas and automobile can both be increased based upon there usage together). In this way, when determining whether a term should be used in the summary, in some embodiments, the higher valued words may be selected and as such, since gas and automobile have been assigned higher values, they will be included in such an embodiment.

In some embodiments, instructions can be provide that are executable to assign a value to each of the number of words based upon the position of each particular word from where it was extracted. For example, if the word is positioned within a phrase that appears to be used as a title in the document, its value can be higher than other terms located elsewhere in the document. A determination of whether a word was in a title can be accomplished in a number of ways, for example, such as the word's proximity to a carriage return, the word's spacing on a page with respect to other words, etc.

In some embodiments, words that accompany words that have been assigned a high value can be selected for use with those high value terms, since it can be inferred in some instances that they are used in the document to provide context to the high value term. As one of ordinary skill in the art will understand, there are many ways to use values assigned to content items to determine whether an item is of greater or lesser importance than other items. Any suitable valuation methods can be used herein to create summary documents that are structured such that they are readable and understandable by a user.

Additionally, as discussed above, in some embodiments, the values of various content: items can be determined at the time of analysis of the document. The values of content items can be also be accessed from values stored in memory accessible to the computing device, in various embodiments.

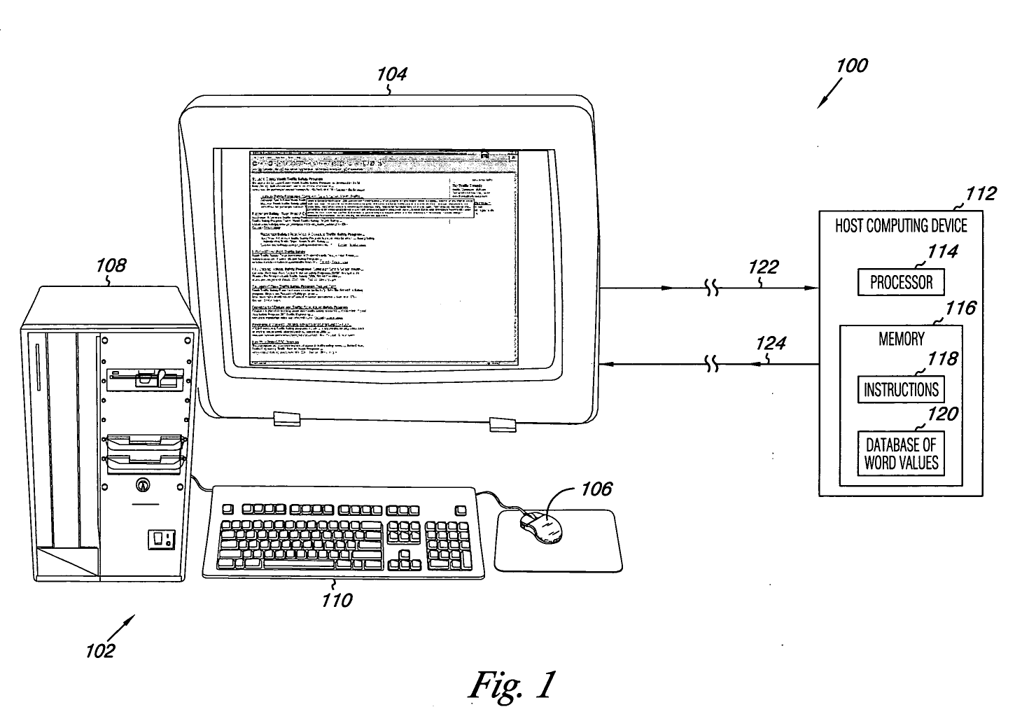

FIG. 1 illustrates a computing system suitable for use with embodiments of the present disclosure. In the embodiment illustrated in FIG. 1, the system 100 includes a user computing device 102 and a host computing device 112.

The user computing device 102 includes a computing portion 108 that includes logic circuitry and memory. In the embodiment of FIG. 1, the computing portion 108 also includes a number of peripherals, such as disk drives for storage of memory therein.

Such devices also typically have other forms of memory including internal hard drives, memory cards with RAM and/or ROM thereon, and/or Flash memory resources. Such memory can also be provided as an external device that can be connected to the computing portion 108 via an input/output (I/O) port.

Other types of I/O devices can also be connected to the computing portion 108 via one or more I/O ports. For example, in the embodiment of FIG. 1, a keyboard 110, a mouse 106, and a display 104 are connected to the computing portion 108.

The various embodiments of the present disclosure, such as that shown in FIG. 1, allow a user, while viewing a document having a hyperlink provided therein, to have access to a summary of the contents of the document to which the hyperlink is directed. For example, as FIG. 1 illustrates, the user is viewing a document (e.g., a web search engine summary page) with a number of hyperlinks displayed thereon.

With a pointing device (e.g., mouse 106, one or more keys on keyboard 110, touch screen 104, etc.) the user can move a cursor (e.g., pointer image) over the hyperlink. With respect to the use of a mouse to control the cursor, this action can be called mousing over a hyperlink.

For simplicity, this term may be used herein to generally refer to the movement of the cursor over a hyperlink whether or not a mouse is the pointing device. In various embodiments of the present disclosure, executable instructions can be used to detect the movement of the cursor over the hyperlink and this positioning can be used as a trigger to initiate the summary creation process.

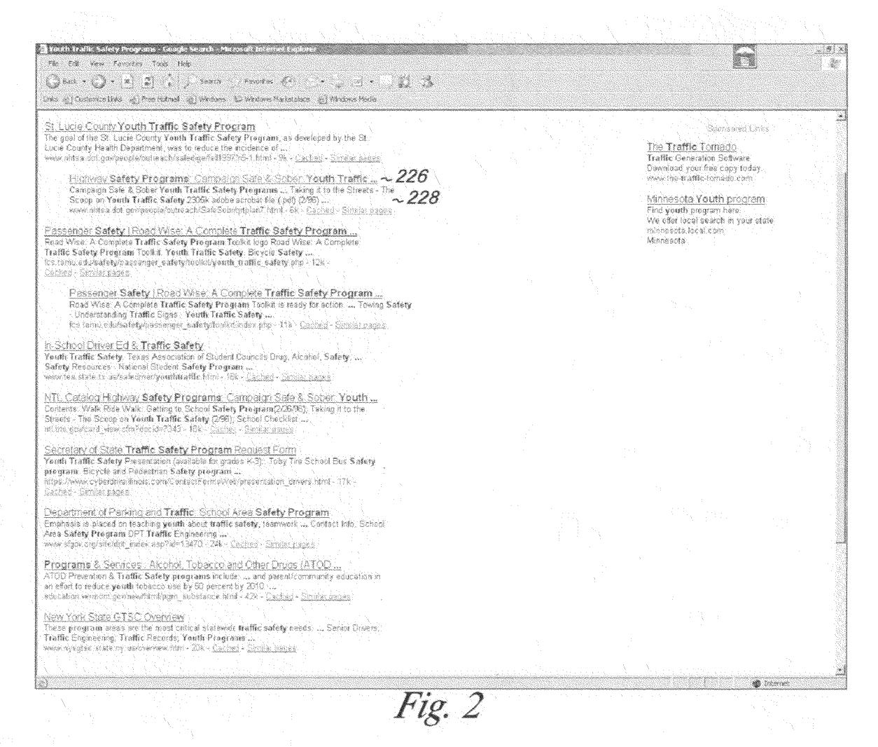

This process will be described in more detail below with respect to FIGS. 2-4B, but generally, computer executable instructions, which can be resident on the user's computing device 102, can initiate a request 122 that is sent to the host computing device 112. This request 122 can be received and processed by the host computing device 112.

In some embodiments, the request 122 can include a number of user defined preferences. For example, in some embodiments, the user can define the length of the summary, the size of the window in which the summary is presented, and/or the level of readability that is to be attained by the host computing device 112 in creating the summary.

As illustrated in the embodiment of FIG. 1, the host computing device 112 can include logic circuitry 114, and memory 116 associated therewith (e.g., included within the computing device and/or connected thereto). Also illustrated in the embodiment of FIG. 1, are a number of executable instructions 118 and a database of word values 120 which, as mentioned above, can be used in various embodiments.

FIG. 2 illustrates a search result having a hyperlink title and a summary. FIG. 2 provides a view of what the user sees when viewing a document before the summary appears.

In this illustration a user is viewing a document which is a webpage of search results that have resulted from a search of the Internet by a search engine. On this document, each search result includes two components, a hyperlink 226 and a number of excerpts 228 from the document showing the context of the keywords which were the basis of the search from which the result was obtained.

In this search, the search keywords were youth, traffic, safety, and program. Accordingly, to aid the user, the search results provided by the webpage can include text which is in bold to indicate which terms were the search terms.

In some instances, the information provided as the hyperlink 226 and/or the excerpts 228, may not provide the user with enough information to determine if the document described is the one they are looking for or are interested in. This can be particularly problematic on news websites, where headlines are shortened to make room for more news stories.

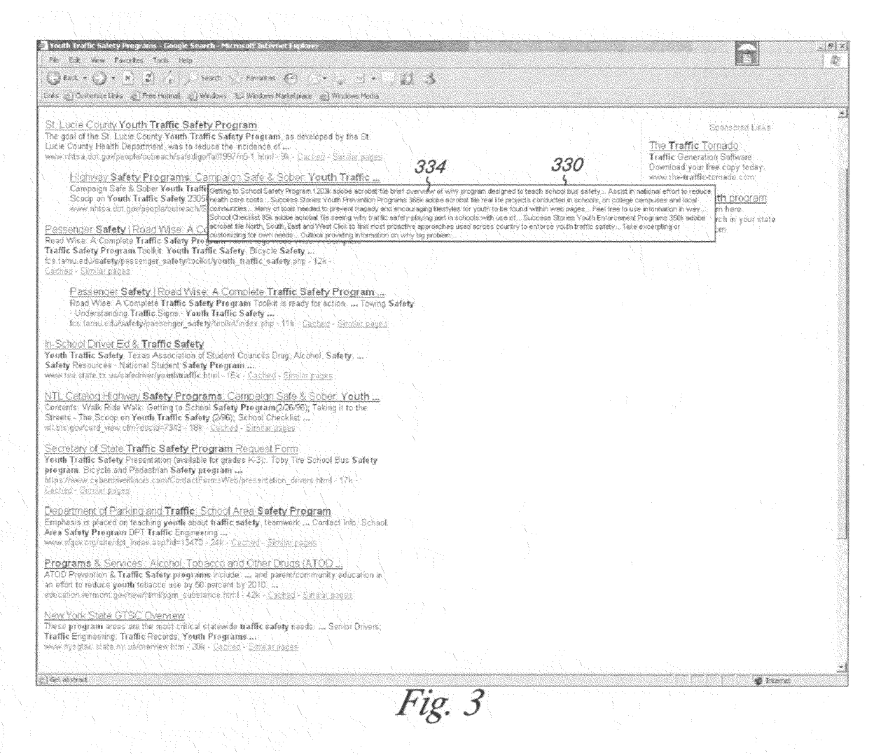

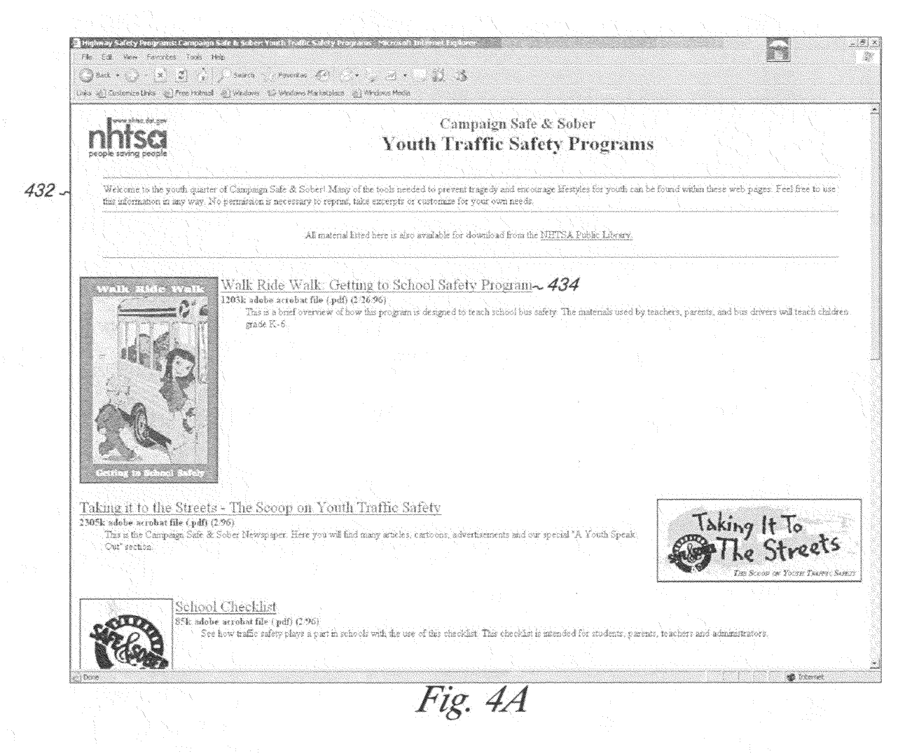

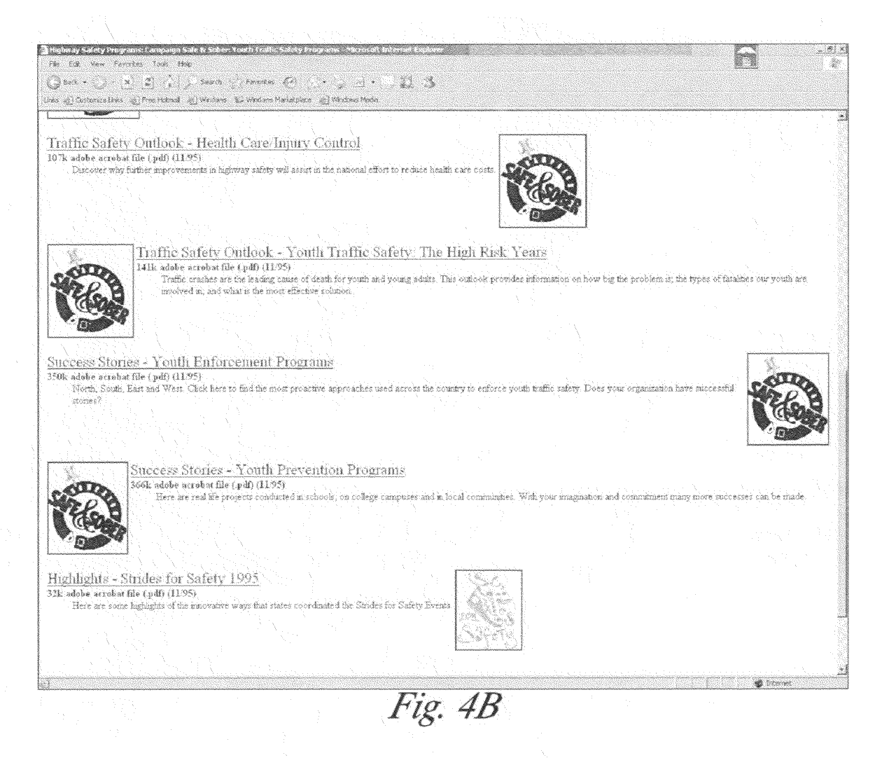

Often, the headlines are used as the text for the hyperlink and are shortened to the point that they do not give much indication as to what they are about, as described above. Accordingly, FIG. 3 provides an example of a summary that can be compiled based upon the content of the document to which the hyperlink is directed (the document is illustrated in FIGS. 4A and 4B) which can be helpful for the user in determining whether the document is the one they were looking for or are interested in, among other benefits.

FIG. 3 illustrates an embodiment of a summarization feature of the present disclosure. In the example illustrated in FIG. 3, executable instructions on the user's computing device (e.g., device 102 of FIG. 1) have initiated a request for a summary of the document (as stated above, the document is illustrated in FIGS. 4A and 4B) identified by hyperlink 226 and excerpts 228 in FIG. 2.

The summary 330 has been prepared and is illustrated in FIG. 3. The summary includes information 334 that is based upon the content of the document that the hyperlink is directed to.

As discussed above, the information 334 provided by the summary can be compiled in a variety of manners. Such compilation can be accomplished, for example, at a host computing device, such as device 112 illustrated in FIG. 1. Such embodiments can be beneficial, for example, because the analysis of the content of the document can take place off of the user's computing device, thereby freeing the user's computing device to provide other functions for the user and/or to provide functionality faster.

Additionally, the use of a host computing device can allow for a more powerful processing computing device to be used, thereby speeding the compilation of a summary or allowing more users to make requests during the same time period. As understood in the art, multiple host computing devices can be used, in some embodiments, to increase processing speed and/or allow for more users to make requests.

FIGS. 4A and 4B illustrate the source content of a document provided in the search result of FIG. 2 and content of the summarization in FIG. 3. In the example illustrated in FIGS. 4A and 4B, FIG. 4A represents the top portion of the document 432 and FIG. 4B represents the bottom portion of the document.

This document includes a number of titles for items and for different sections of the document. For example, item 434 is a title of a program brochure that is offered on this website. As discussed above, various words within the content of the document can be assigned values and the values can be used to determine whether the word is to be used in the summary and the position of the word in the context of the summary when compiled.

As discussed above, such title information can be given greater value than non-title information, in some embodiments. As such, this information may be more likely to be used in forming the summary, in such embodiments.

As shown in the summary 330 of FIG. 3, the first words used are “Getting to School Safety Program”. When correlated to the language from the document illustrated in FIGS. 4A and 4B, this information is illustrated as being part of the title 434.

Symbols, such as the colon symbol used in title 434 of FIG. 4A can be analyzed as content items as defined herein and can affect the value of one or more words to be included in the summary. For example, in FIG. 4A, the use of a colon can be interpreted as the signal for information that can be used as a title of an item. In such a way, executable instructions can be used to assign a higher value to information after the colon.

Unless explicitly stated, the method embodiments described herein are not constrained to a particular order or sequence. Additionally, some of the described method embodiments can occur or be performed at the same point in time.

Although specific embodiments have been illustrated and described herein, those of ordinary skill in the relevant art will appreciate that an arrangement calculated to achieve the same techniques can be substituted for the specific embodiments shown. This disclosure is intended to cover all adaptations or variations of various embodiments of the present disclosure.

It is to be understood that the above description has been made in an illustrative fashion, and not a restrictive one. Combination of the above embodiments, and other embodiments not specifically described herein, will be apparent to those of ordinary skill in the relevant art upon reviewing the above description.

The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure need to use more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method of hyperlink content abstraction, comprising:
selecting a hyperlink with a user directed pointing device;
implementing computing device executable instructions to access an electronic document linked to the hyperlink;
analyzing a number of content items within the electronic document to determine the content of the document; and
compiling a summary of the content of the electronic document based upon the analysis.

2. The method of claim 1, where analyzing a number of content items includes executing computing device executable instructions to analyze a number of words within the electronic document.

3. The method of claim 1, where analyzing a number of content items includes obtaining a copy of the electronic document and executing computing device executable instructions to analyze a number of words within the electronic document.

4. The method of claim 1, where analyzing a number of content items includes executing computing device executable instructions to interpret a value of a particular content item with respect to the electronic document based upon a value for the particular content item assigned with respect to a neutral context.

5. The method of claim 1, where analyzing a number of content items includes executing computing device executable instructions to interpret a value of a particular content item with respect to the electronic document based upon a value for the particular content item assigned with respect to at least one other content item in the electronic document.

6. A computing device readable medium having executable instructions stored thereon to be executed by a computing device to perform a method comprising:
receiving a request for a summary of a document from a user based upon the user's selection of a hyperlink;
accessing an electronic document linked to the hyperlink based upon information received in the request;
analyzing a number of content items within the document to determine the content of the document; and
compiling a summary of the content of the document based upon the analysis of the number of content items.

7. The medium of claim 6, where receiving a request for a summary of a document includes receiving a request for a summary of a word processing document.

8. The medium of claim 6, where receiving a request for a summary of a document includes receiving a request for a summary of a hyper text markup language document.

9. The medium of claim 8, where receiving a request for a summary of a document includes receiving a request for a summary of a portable document format document.

10. The medium of claim 8, where receiving a request for a summary of a document includes receiving a request for a summary of an extensible markup language document.

11. A computing device, comprising:
a processor;
a memory coupled to the processor; and
instructions storable in the memory and executable by the processor to:
receive a request for a summary of a document from a user based upon the user's selection of a hyperlink;
access an electronic document linked to the hyperlink based upon information received in the request;
analyze a number of words within the document to determine the content of the document; and
extract a number of words from the content of the document and compile a summary based the number of words extracted and upon the analysis of the number of words.

12. The computing device of claim 11, where the instructions are executable to modify one or more of the extracted words based upon a proposed position within the summary.

13. The computing device of claim 11, where the instructions are executable to use exactly the extracted words in compiling the summary.

14. The computing device of claim 11, where the instructions are executable to compile the summary from a number of words and where positions of the words of the summary are based upon a proposed word order structure for the summary.

15. The computing device of claim 11, where the instructions are executable to access a database of values that have been assigned to each of the number of words.

16. The computing device of claim 11, where the instructions are executable to compile the summary from a number of words and where positions of the words of the summary are based upon a proposed sentence structure for the summary.

17. The computing device of claim 11, where the instructions are executable to compile the summary from a number of words, to assign a value to each word, and to position each of the words of the summary based upon a comparison of the values assigned to each of the number of words.

18. The computing device of claim 11, where the instructions are executable to compile the summary from a number of words, to access a database of values that have been assigned to each of the number of words, and to position each of the words of the summary based upon a comparison of the values assigned to each of the number of words obtained from the database.

19. The computing device of claim 11, where the instructions are executable to assign a value to each of the number of words.

20. The computing device of claim 11, where the instructions are executable to assign a value to each of the number of words based upon the position of each particular word from where it was extracted.

21. The computing device of claim 11, where the instructions are executable to assign a value to each of the number of words based upon the usage of each particular word in the content from which it was extracted.
